(19) United States
(12) Patent Application Publication
(10) Pub. No.: US 2013/0082027 A1
(43) Pub. Date: Apr. 4, 2013

(54) METHOD FOR MANUFACTURING A PERPENDICULAR MAGNETIC WRITE HEAD USING NOVEL REACTIVE ION ETCHING CHEMISTRY

(71) Applicants: Guomin Mao, San Jose, CA (US); Donald G. Allen, Morgan Hill, CA (US); Aron Pentek, San Jose, CA (US); Thomas J. A. Roucoux, San Jose, CA (US); Yi Zheng, San Ramon, CA (US)

(72) Inventors: Guomin Mao, San Jose, CA (US); Donald G. Allen, Morgan Hill, CA (US); Aron Pentek, San Jose, CA (US); Thomas J. A. Roucoux, San Jose, CA (US); Yi Zheng, San Ramon, CA (US)

(73) Assignee: Hitachi Global Storage Technologies Netherlands B.V., Amsterdam (NL)

(21) Appl. No.: 13/251,058

(22) Filed: Sep. 30, 2011

(51) Int. Cl. G11B 5/127

(52) U.S. Cl. 216/22; 216/41

(57) ABSTRACT

A method for manufacturing a magnetic write head for magnetic data recording. The method includes forming a depositing a magnetic write pole material and forming a mask structure over the write pole material that includes a polymer mask under-layer, a dielectric hard mask formed over the polymer mask under-layer and a photoresist mask formed over the dielectric hard mask. The image of the photoresist mask is transferred onto the underlying dielectric hard mask and then a reactive ion etching is performed to transfer the image of the dielectric hard mask onto the polymer mask under-layer. This reactive ion etching is performed in an atmosphere chemistry that includes both an oxygen containing gas and a nitrogen containing gas.

### FIELD OF THE INVENTION

The present invention relates to perpendicular magnetic recording and more particularly to a method for manufacturing a magnetic write pole using a novel multi-gas chemistry during reactive ion etching of a write pole defining polymer mask under-layer.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension amr to place the read and write heads over selected circular tracks on the rotating disk. The read and write heads are directly located on a slider that has an air bearing surface (ABS). The suspension arm biases the slider toward the surface of the disk, and when the disk rotates air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head can include a magnetic write pole and a magnetic return pole, the write pole having a much smaller cross section at the ABS than the return pole. The magnetic write pole and return pole are magnetically connected with one another at a region removed from the ABS. An electrically conductive write coil induces a magnetic flux through the write coil. This results in a magnetic write field being emitted toward the adjacent magnetic medium, the write field being substantially perpendicular to the surface of the medium (although it can be canted somewhat, such as by a trailing shield located near the write pole). The magnetic write field locally magnetizes the medium and then travels through the medium and returns to the write head at the location of the return pole where it is sufficiently spread out and weak that it does not erase previously recorded bits of data.

A magnetoresistive sensor such as a GMR or TMR sensor can be employed for sensing magnetic fields from the rotating magnetic disk. The sensor includes a nonmagnetic conductive layer, or barrier layer, sandwiched between first and second ferromagnetic layers, referred to as a pinned layer and a free layer. First and second leads are connected to the sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos Θ, where Θ is the angle between the magnetizations of the pinned and free layers. In a read mode, the resistance of the spin valve sensor changes proportionally to the magnitudes of the magnetic fields from the rotating disk. When a sense current is conducted through the spin valve sensor, resistance changes cause potential changes that are detected and processed as playback signals.

At very small bit sizes it is very important to define the write pole very accurately. For example, processes used to manufacture the write pole defining mask structure can result in the mask structure being poorly defined, with rough sidewalls, irregular undercuts and other deformities. This makes an accurate definition of the write pole difficult to achieve.

### SUMMARY OF THE INVENTION

The present invention provides a method for manufacturing a magnetic write head that includes, depositing a magnetic write pole material, and after depositing the magnetic write pole material, depositing a polymer mask under-layer. A dielectric hard mask is deposited over the polymer mask under-layer, and a photoresist mask is formed. The image of the photoresist mask is transferred onto the dielectric hard mask, and a reactive ion etching is performed to transfer the image of the dielectric hard mask onto the under-layer polymer mask layer, the reactive ion etching (RIE) being performed in a chemistry that includes an oxygen containing gas and a nitrogen containing gas.

The presence of both the oxygen containing gas and the nitrogen containing gas advantageously allows the polymer mask under-layer to be formed with smooth, straight well defined side walls, without footing, with little to no undercutting or other defects. This allows the write pole to be more accurately defined by a subsequent ion milling process that transfers the pattern of the polymer mask under-layer onto the magnetic write pole material.

The invention presents an alternate process method to fabricate magnetic laminate write heads. This new method uses a novel RIE plasma chemistry to etch the under-layer pole mask by introducing a certain amount of non-oxygen containing gas into an oxygen containing atmosphere, such as a carbon dioxide (CO₂) dominated plasma. The results of this two-gas chemistry showed dramatically different performance from the CO₂ only etching. The geometry of the polymer mask under-layer is more controllable, the defects such as irregular undercuts are minimized and bottom footing is completely removed. More importantly, the side walls of the polymer mask under-layer are much smoother, the cross-sectional profile of the under-layer is much better controlled toward the desired shape required by the subsequent mill process. In addition, it gives wider process margin for the subsequent ion milling.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view of a magnetic head, taken from line 3-3 of FIG. 2 and rotated 90 degrees counterclockwise, of a magnetic head according to an embodiment of the present invention;

FIG. 4 is an enlarged ABS view of a portion of the write head of FIG. 3;

FIG. 5 is a top down view of a write pole of the write head of FIG. 4;

FIGS. 6-10 are views of a portion of a write head in various intermediate stages of manufacture, illustrating a method of manufacturing a magnetic write head according to an embodiment of the invention; and

FIGS. 11 and 12 are views of a mask structure defined according to a process that does not include the inventive reactive ion etching process.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

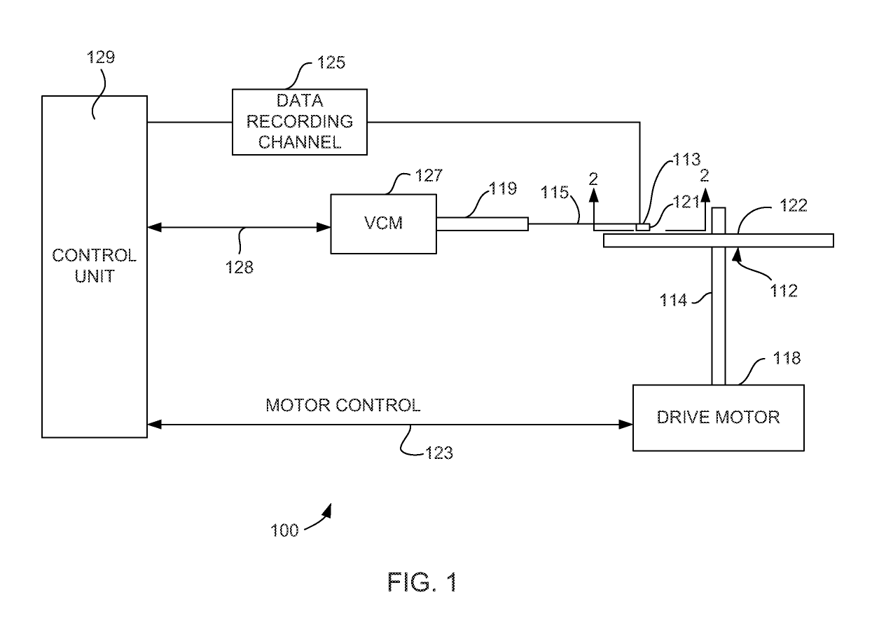

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

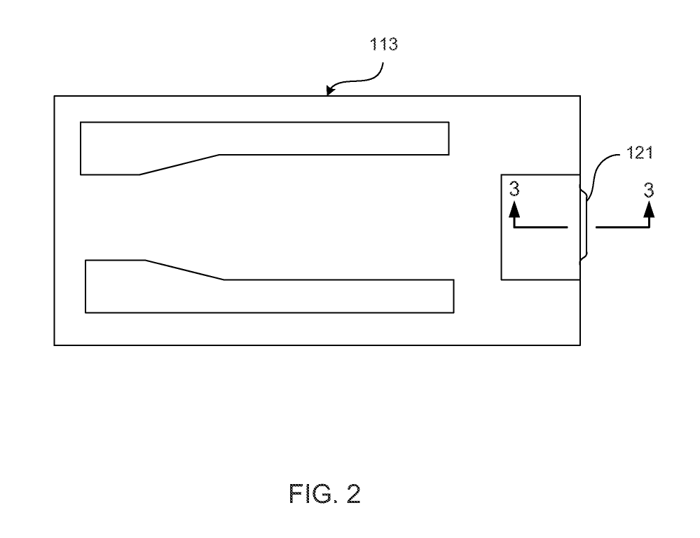

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

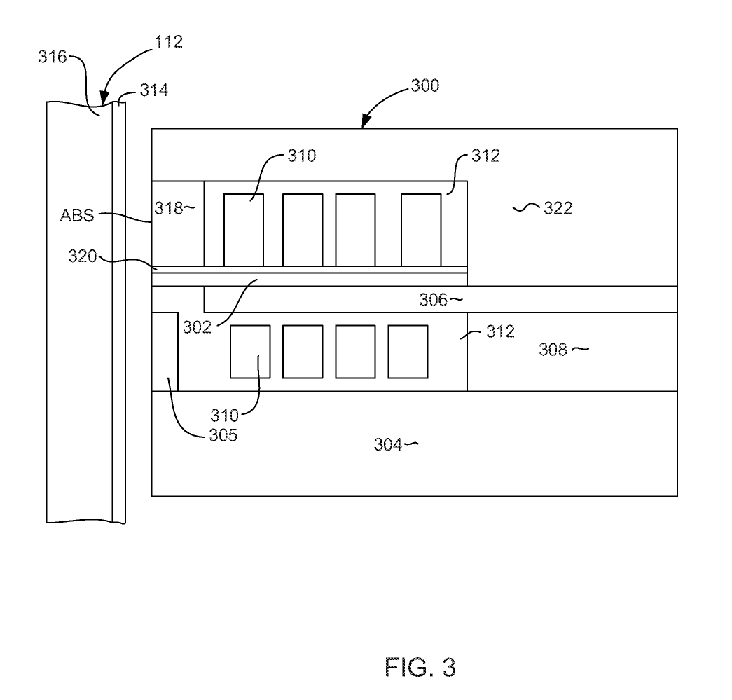

FIG. 3 is a side cross sectional view of a magnetic write head 300 that can be constructed by a method of the present invention. The write head 300 includes a magnetic write pole 302 and a magnetic return pole 304. The magnetic write pole 302 can be connected with a magnetic shaping layer 306 that helps to conduct magnetic flux to the tip of the write pole 302. The write pole 302 and shaping layer 306 can be connected with the magnetic return pole 304 by a magnetic back gap structure 308. A non-magnetic, electrically conductive write coil 310 passes between the return pole 304 and the write pole and shaping layer 302, 306, and may also pass above the write pole and shaping layer 302, 306. The write coil 310 can be encased in a non-magnetic, electrically insulating material 312, which can be a material such as alumina and/or hard baked photoresist. When an electrical current flows through the write coil 310 a magnetic field is induced around the coil 310 that results in a magnetic flux flowing through the return pole 304, back gap layer 308, shaping layer 306 and write pole 302. This results in a write field being emitted from the tip of the write pole 302. This strong, highly concentrated write field locally magnetizes a magnetic top layer 314 of the magnetic media 112. The magnetic field then travels through a soft magnetic under-layer 316 of the magnetic media before returning to the return pole 304, where it is sufficiently spread out and weak that it does not erase the previously recorded bit of data. The write head 300 can also include a magnetic pedestal 305, at the ABS that acts as a shield to prevent stray fields, such as those from the write coil 310 from reaching the magnetic medium 112.

The write head 300 may also include a trailing magnetic shield 318, located at the air bearing surface (ABS) and separated from the write pole 302 by a non-magnetic trailing gap layer 320. The trailing magnetic shield 318 can be connected with the other magnetic structures at the back of the write head 300 by a trailing magnetic pole 322.

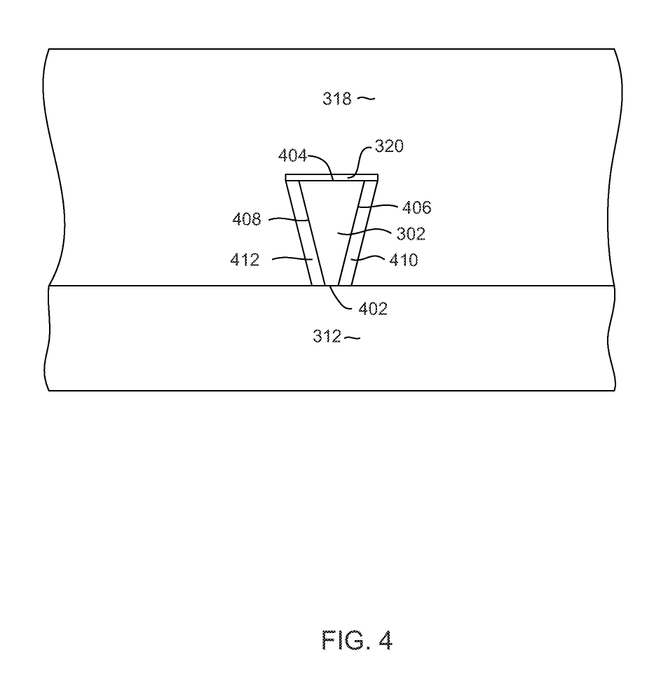

FIG. 4 is an air bearing surface view (ABS view) of a portion of the magnetic write head 300 of FIG. 3. The view in FIG. 4 is enlarged to more clearly show the write pole 302. In FIG. 4 it can be seen that the write pole 302 has a trapezoidal shape, having a leading edge 402, and a trailing edge 404 and first and second laterally opposed sides 406, 408 that each extend from the leading edge 402 to the trailing edge 404. The leading edge is preferably narrower than the trailing edge, and in many cases, the leading edge is so narrow that its width is virtually zero that the ABS becomes a triangle shape. This shape helps to reduce skew related adjacent track interference when the head is at an extreme inner or outer radial location over the media 112 (FIG. 1). Also as can be seen, the trailing magnetic shield 318 can extend down the sides of the write pole 302 to provide a side shielding function to prevent stray fields from reaching and affecting the magnetic media. The side portions of the shield 318 are separated from the sides 406, 408 of the write pole 302 by non-magnetic side gap layers 410, 412.

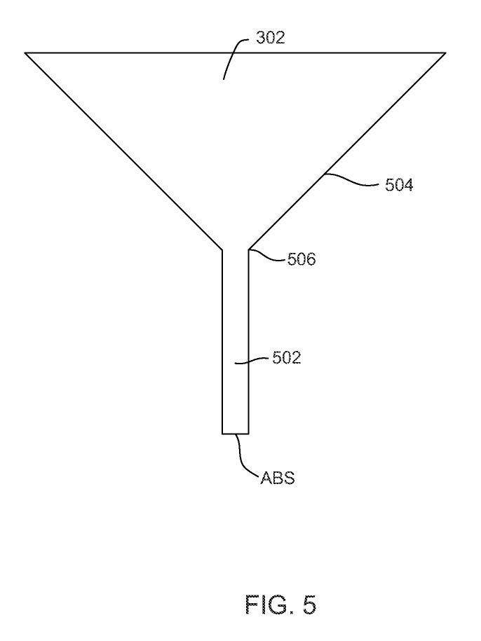

FIG. 5 shows a top down view of the write pole 302. As can be seen in FIG. 5, the write pole 302 has a narrow pole tip portion 502 that can be formed with a relatively constant cross section, and a flared portion 504. The junction between the constant cross section pole tip portion 502 and the flared portion 504 defines a flare point 506. The location of this flare point relative to the ABS is an important parameter to the performance of the write head 302.

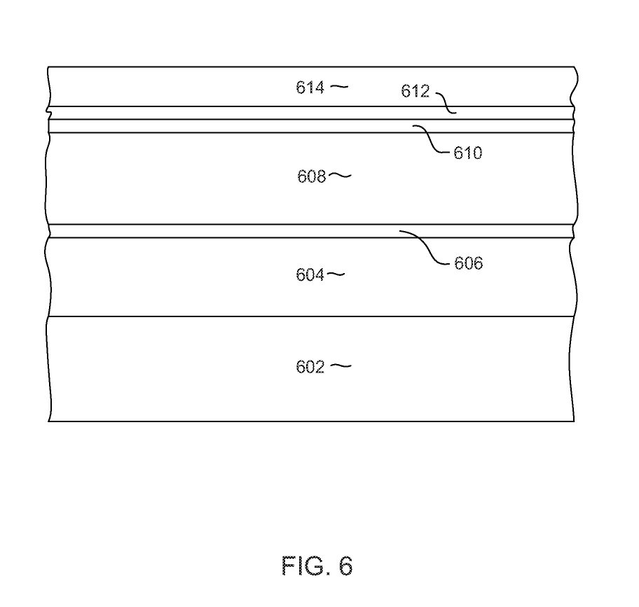

FIGS. 6-10 show a write pole in various intermediate stages of manufacture in order to illustrate a method of manufacturing a magnetic write head according to an embodiment of the invention. With particular reference to FIG. 6, a substrate 602 is provided. The substrate can be include a portion of the non-magnetic material 312 of FIG. 3 and at least a portion of the shaping layer 306 of FIG. 3. A magnetic laminate structure 604 is deposited over the substrate 602. The magnetic laminate structure 604 can include layers of magnetic material such as CoFe separated from one another by thin layers of non-magnetic material. For purposes of simplicity, the laminated structure 604 is shown as a single layer in FIG. 6. An ion milling hard mask 606 is deposited over the laminate 604. The ion milling hard mask can be constructed of a material such as Diamond Like Carbon (DLC), carbon, alumina (Al₂O₃), Ta etc. A polymer mask under-layer 608 is deposited over the ion milling hard mask layer 606, and a dielectric hard mask 610 is deposited over the under-layer 608. The under-layer 608 is preferably constructed of a polymeric material that can be cured at a relatively low temperature, such as around 150 to 250 degrees C. Examples of such polymeric materials include SRJL® (Shin-Etsu Chemical Co., Ltd.), DUJRIMIDE® (Fujifilm Corporation), JSR HM8006® (Honeywell International Inc.), ACCUFLO T-31® (Honeywell International Inc.) and etc.

This under-layer 608 (which also can be referred to as an image transfer layer) provides masking during an ion milling process that will be described herein below. The thickness of the under-layer 608 depends upon the duration and strength of the ion milling that will be performed to define the write pole, however the layer 608 can be from a few hundred nanometers to more than two thousand nanometers.

The dielectric hard mask layer 610 can be constructed of a dielectric material and is preferably constructed of a Si containing hard mask material such as silicon oxide, silicon nitride, silicon oxynitride or a silicon containing organic material such as SIHM® (Shin-Etsu Chemical Co., Ltd.), UVAS (Floneywell International Inc.) and etc. The thickness of the dielectric hard mask 610 depends on the thickness of the underlayer 608. Generally, the thicker the under-layer 608, the thicker the dielectric hard mask 610 will have to be. An optional Bottom Anti-Reflective Coating (BARC) 612 may be applied over the dielectric hard mask 610. The determination of whether a BARC layer 612 is needed depends on the requirements of the photolithograph and on the material used for the dielectric hard mask 610. For example, if the dielectric hard mask 610 itself is a material that acts as a BARC, then no BARC layer 612 is needed. Such materials include silicon oxynitride, SIHM (Shin-Etsu Chemical Co., Ltd.), UVAS (Honeywell International Inc.). Also, no BARC 612 is needed if the dielectric hard mask 610 is sufficiently thin and the critical dimensions of the magnetic pole are large enough that the under-layer 608 can function as a BARC. However, some form of BARC is desirable to control photolithography parameters such as reflective swing and photo critical dimensions.

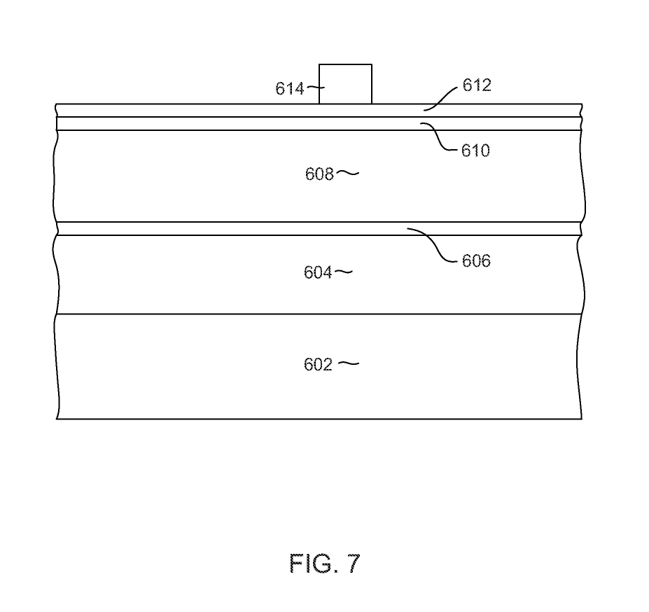

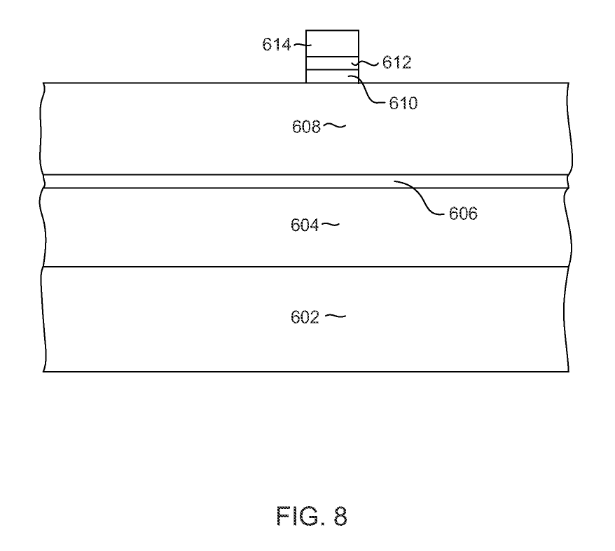

After deposition of the layers 604, 606, 608, 610 and option layer 612, a layer of photoresist 614 is deposited. The thickness of the photoresist must be thick enough to effectively mask the BARC 612 and/or dielectric hard mask 610 when transferring the image of the photoresist mask onto the dielectric hard mask 610 (as will be described below). The photoresist layer 614 is photolithographically patterned to define a write pole defining mask, leaving a structure as shown in FIG. 7. Then, a first Reactive Ion Etching (RIE) is performed to transfer the image of the photoresist mask 614 onto the under-lying dielectric hard mask by removing portions of the dielectric hard mask 610 that are not protected by the photoresist mask 614, leaving a structure as shown in FIG. 8.

As shown in FIG. 8, the reactive ion etching removes a portion of the photoresist mask 614 as well. This first RIE is preferably performed in a fluorine containing plasma chemistry such as one that contains CF₄, CHF₃, Ar, etc. or a combination of these.

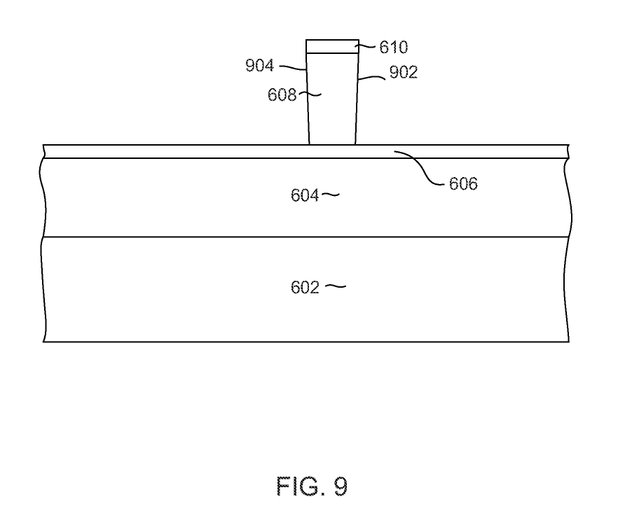

A second RIE process is then performed to transfer the image of the dielectric hard mask 610 onto the under-layer 608 by removing portions of the layer 608 that are not protected by the dielectric hard mask 610, leaving a structure as shown in FIG. 9. As can also be seen in FIG. 9, this second RIE also removes the remaining photoresist mask 614 (FIG. 8), the BARC layer 612 (if it is used) and portion of the dielectric hard mask 610. This second RIE is a novel RIE performed using a multi-gas chemistry. The novelty and advantages of this multi-gas RIE will be described in greater detail herein below. As can be seen in FIG. 9, the patterned under-layer 608 has smooth straight sidewalls 902, 904 and has a slightly trapezoidal shape with the bottom of the layer 608 having a slightly smaller width than the top of the layer 608. However, as mentioned above, these sidewalls 902, 904 are straight all of the way from the top to the bottom.

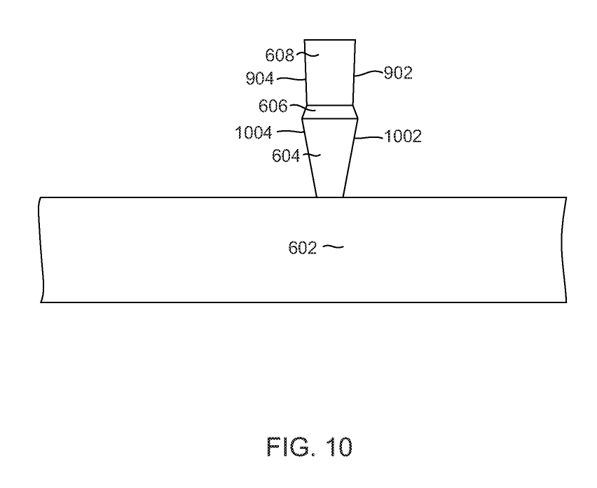

After under-layer 608 has been patterned as described above, an ion milling is performed to transfer the image of the patterned under-layer 608 onto the under-lying ion milling mask 606 and magnetic laminate material 604, leaving a structure as shown in FIG. 10. The ion milling can include a sweeping ion milling and can be performed at one or more angles relative to normal in order to form a write pole 604 having tapered side walls 1002, 1004 as shown. The ion milling removes the remaining dielectric hard mask 610 (FIG. 9) and also consumes a portion of the under-layer 608, so the under-layer 608 is shorter after ion milling than before.

As can be seen, the patterned under-layer 608 defines the shape of the final, formed write pole 604. Therefore, it is important that the shape of the under-layer 608 be very well defined, and especially that the sides 902, 904 are well defined.

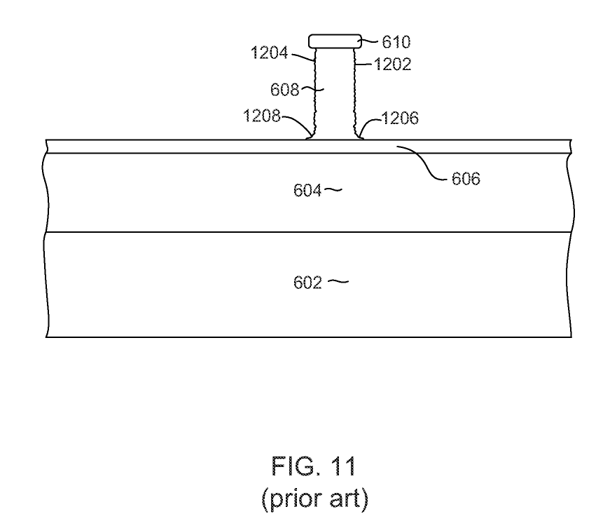

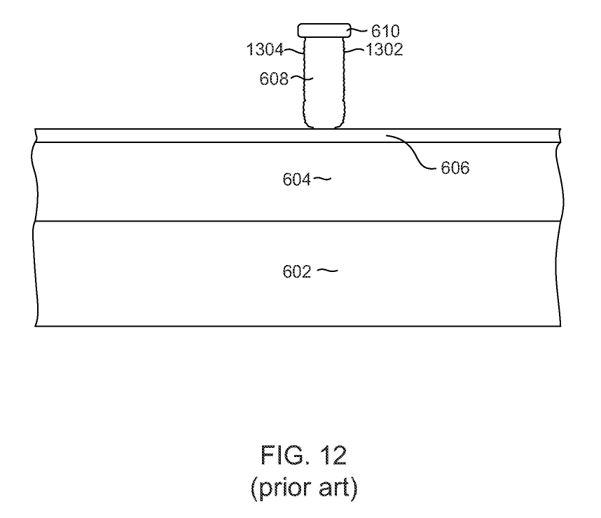

FIGS. 11 and 12 show examples of structures with under-layers 608 that have been patterned without use of the novel RIE process of the invention. In FIG. 11 the under-layer 608 has sides 1202, 1204 that are not straight and smooth but are rough and poorly defined. In addition, it can be seen that the sides 1202, 1204 not aligned with the outer edges of the dielectric hard mask 610. Rather, the under-layer 608 is actually narrower than the dielectric hard mask 610. Therefore, the width of the final write pole cannot be accurately controlled or defined by such an under-layer. Also, as shown in FIG. 11, the base of the under-layer 608 has footings 1206, 1208 where the bottom of the under-layer 608 actually spreads outward, and this spread is not controllable so that the footing shape and outward extension may have random variations at both sides the underlayer pole.

FIG. 12 illustrates another problem that can arise from prior art RIE patterning processes. In FIG. 12 it can be seen that the under-layer 608 has sides 1302, 1304 that are under-cut irregularly at the bottom. Therefore, width of the under-layer 608 actually decreases uncontrollably at the bottom. Both the footing and described undercut would severely affect the ability to accurately define a write pole by ion milling.

As mentioned above, the present invention utilizes a novel reactive ion etching process that overcomes these challenges described above with reference to FIGS. 11 and 12 and which results in a well defined patterned under-layer 608 as shown in FIG. 9. In order to better understand this novel reactive ion etching it is desirable to give a brief description of a tool in which this reactive ion etching takes place.

One plasma tool especially suitable for the RIE process to etch the Si containing hard mask material and polymer mask under-layer is Plasma-Therm's Versalock™ etcher, which is an inductively coupled plasma (ICP) etch system in which the plasma is generated by means of inductively coupling 2 MHz RF power (the source power) while independently controlling the ion energy directed toward the substrate via 13.56 MHz bias power. This separate power control allows for the conduction of wider RIE processes ranging from highly chemical processes to highly physical processes. The Versalock etcher is equipped with Optical Emission Spectrometry (OES) endpoint system that the over-etch amount can be precisely controlled via the determination of etch endpoint.

Many Other ICP etchers equipped with both source and bias power suppliers, such as TCP® 9400DFM from Lam Research Inc., or DPS® from Applied Materials Inc., can also be used for the RIE process of the Si containing hard mask material and polymer mask under-layer. We expect that the RE process presented in this art can be transferable transparently in different ICP etchers. If fact, our test in TCP® 9400DFM from Lam Research Inc. confirmed that it could give the same results as we have obtained in Plasma-Therm's Versalock™ etcher by doing minor tuning of the RIE parameters.

As discussed above, an ideal under-layer 608 should have such features that the cross section of the pole is a slightly tapered trapezoid with little bit smaller bottom CD than top CD and the edge profile must be straight and smooth, also there should be no top/bottom undercut and no bottom footing as shown in FIGS. 11 and 12. However, in reality, the shape and profile of the under-layer pole fabricated by using CO₂ only plasma may create various defects as described with reference to FIGS. 11 and 12, which cause several issues for the subsequent dry pole ion milling process and which tend to lower the production yield of the main pole. These issues may occur at different locations on the wafer and may also vary from wafer to wafer. Moreover, they may become more severe when the size of the ABS is shrunk to even smaller dimension for future generations of magnetic disc drives. To resolve these issues and to improve the production yield, the new RIE etching process forms an under-layer 608 that is closer to the ideal one (as illustrated in FIG. 9).

The features of the under-layer 608 formed by this new plasma chemistry are dramatically different from the conventional ones in several respects:

1) The roughness on the side walls 902, 904 of the under-layer 608 is dramatically reduced and the edge profile is much smoother. Therefore, it is expected that there will be much less re-deposition on the side wall of the under-layer 608 during ion milling process.

2) The shape of the under-layer 608 is basically tapered with a slightly larger top CD and smaller bottom CD, as described with reference to FIG. 9. However, the lower part of the under-layer has more taper profile than the upper part of the pole, which might be due to the over etch effect. During over etch, the plasma is stopped on the ion mill hard mask 606, the plasma does not only etch away the residues left-over on the surface of the ion mill hard mask 606 during the second reactive ion etch but also trims the side wall of the under-layer 608. This plasma trimming attacks more of the under-layer 608 at the bottom of the under-layer 608, thus the bottom part of the under-layer 608 tends to shrink more than the top part.

3) There is very little or no top undercut, thus eliminating the metal re-deposition at top of the under-layer 608 during ion milling.

4) There is no footing found at the bottom of the under-layer 608, which gives better control on both CD and shape of the laminate poles 604 during the subsequent ion milling process.

Unlike the conventional RIE processes in which only oxygen containing gases (carbon dioxide (CO₂) or oxygen (O₂) are used to produce the plasma to etch the under-layer, in the newly developed RIE process, a certain amount of nitrogen (Ne) gas is added to oxygen containing plasma. The addition of nitrogen (Nz) provides a different plasma chemistry in etching the under-layer 608 and provides an opportunity to re-tune the RIE process to reach desired parameters. Development was focused on carbon dioxide (CO₂) and nitrogen (N₂) plasma. The process tuning of this two-gas plasma chemistry can be optimized by adjusting the following parameters, the relative ratio of carbon dioxide (CO₂) gas flow to nitrogen gas (N₂) flow, the total amount of carbon dioxide and nitrogen gas flow, the gas pressure of the plasma chamber, the input amount of the bias power, and the input amount of source power, the relative ratio of bias power to source power, the over-etch amount, the temperature of the wafer (or the temperature of the chuck on which the wafer is held) and back side helium cooling pressure. However, the last two parameters have relatively less sensitive effect on process tuning as other RIE parameters and are also not so convenient to adjust due to the restriction of tool sharing with many other production processes and thus usually remain as constant throughout entire testing.

While the total gas flow is limited by the hardware of the reactive ion etching tool (such as gas flow meter and chamber pressure controlling), the gas ratio between carbon dioxide and nitrogen can be adjusted in a certain range which could give desired effects. The range of the gas ratio (gas flow of carbon dioxide to gas flow of nitrogen) can vary from 15 to 1.5. If the gas ratio is beyond the high limit, then there is so little nitrogen in the mixed gas that the effect of nitrogen may not be effective, the plasma chemistry is more close to that of the pure carbon dioxide, the profile of the etched under-layer pole is toward that of pure carbon dioxide and thus cause undesired footing at tihe bottom of the under-layer pole and roughness on the side wall of the under-layer pole. If the gas ratio is below the low end limit, then there is too much nitrogen which causes three undesired results: more curved side wall profile on the upper part of the under-layer 608, a broader CD at near the top of the pole, and faster shoulder erosion of the dielectric hard mask.

Besides the adjustment of the gas ratio, other parameters such as the chamber pressure can also be changed to assist process tuning. In test, the chamber pressure was kept in the range of 2 to 10 mT. A pressure lower than this range may cause pressure control issue due to the hardware limitations, and higher pressure may cause profile issues such as excessive bottom undercut and CD shrinkage and also may produce more roughness on side wall of the under-layer 608 due to the excessive isotropic etch to the side wall. In addition, the power ratio (bias-power to source power) also plays important role in the process tuning, the desirable range of the power ratio (bias power/source power) is from 0.5 to 1.5. Generally, the higher the power ratio is the less the top under-cut and CD shrinkage will be. For even lower power ratios, too much isotropic etching from source power causes more side-wall etching which may give rise too much top and bottom undercut, plus the profile of the under-layer 608 will be more tapered, and the side wall will get rougher. For higher power ratio, too high of a bias-power means more physical etching such that the dielectric hard mask get eroded much faster, especially at the shoulder of the mask which may cause quick rounding of the dielectric hard mask 610 and causing loss of mask function.

The mechanism by which the addition of nitrogen to carbon dioxide reduces the roughness of the side wall of the polymer mask under layer 608 during plasma etching is not clear yet. Further research and study are necessary to figure out the mechanism. One possible mechanism is that the nitrogen radicals or nitrogen ions may clean the surface of the side wall of the under layer 608 which may have re-deposition containing carbon/nitrogen complexes and make the side wall smooth. With existence of nitrogen in plasma during etching of the under-layer 608, the re-deposition of the carbon/nitrogen containing materials created during RIE etching of the under-layer can be instantaneously removed when it is formed, therefore, the side wails 902, 904 of the under-layer 608 are always re-deposition free, thus keeping the side walls 902, 904 smooth. Another possible mechanism is that nitrogen radicals or nitrogen ions are a much gentler etchant than oxygen or oxygen containing radicals/ions, so that the plasma attacking of the side walls 902, 904 of the under-layer 608 is reduced with the addition of nitrogen, this may relate with the phenomena that with more addition of nitrogen that the top CD of the under-layer 608 gets larger. That is, the nitrogen is more effective at removing the re-deposition on the wall surface of the under-layer 608 but has less etching ability on the materials of the pole, where the chemical compositions of the re-deposition may be different from those of the under-layer material 608.

The importance of this newly developed etching process for patterning of the under-layer mask 608 is that it produces much smoother side walls 902, 904 than the conventional process, that it will not allow the re-deposition exist during ion milling process, and that it produces the right main pole shape and profile. In addition, since there is no top undercut, that also eliminates the re-deposition under the dielectric mask which often causes problem with regard to ion milled ABS poles. Moreover, it gives a better control to both of the top and bottom CD which are critical to the final CD control of the main pole. Overall, the new process to fabricate under-layer mask 608 gives better performance over conventional processes and is being used in fabrication of the new generations of the magnetic writer heads and is also expected to be applied to fabricating the more advanced generations of the magnetic writer heads.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for manufacturing a magnetic write head, comprising:
depositing a magnetic write pole material;
after depositing the magnetic write pole material, depositing a polymer mask under-layer;
depositing a dielectric hard mask over the polymer mask under-layer;
forming a photoresist mask;
transferring the image of the photoresist mask onto the dielectric hard mask; and
performing a reactive ion etching to transfer the image of the dielectric hard mask onto the under-layer mask layer, the reactive ion etching being performed in a chemistry that includes an oxygen containing gas and a nitrogen containing gas.

2. The method as in claim 1 further comprising, after performing the reactive ion etching, performing an ion milling to transfer the image of the under-layer onto the magnetic write pole material, thereby defining a magnetic write pole.

3. The method as in claim 1 further comprising, after depositing the magnetic write pole material and before depositing the polymer mask under-layer, depositing a dielectric hard mask layer.

4. The method as in claim 1 wherein the under-layer comprises a polymer mask.

5. The method as in claim 1 wherein the under-layer comprises a polymer mask film having a curing temperature of about 150 to 250 degrees C.

6. The method as in claim 1 further comprising after depositing the dielectric hard mask and before forming the photoresist mask, depositing a Bottom Antireflective Coating.

7. The method as in claim 1 wherein the reactive ion etching is performed in a chemistry that includes a mixture of CO₂ and N₂.

8. The method as in claim 1 wherein the ratio of bias power to source power is 0.5 to 1.5.

9. The method as in claim 1 wherein the gas flow ratio of oxygen containing gas to nitrogen containing gas is 15 to 1.5.

10. The method as in claim 1 wherein the reactive ion etching is performed at a total 2 pressure of 2 to 10 nmT.

11. A method for manufacturing a magnetic write head, comprising:
providing a wafer;
depositing a magnetic write pole material on the wafer;
depositing an ion milling hard mask on the magnetic write pole material;
depositing a polymer mask under-layer over the ion milling hard mask;
depositing a dielectric hard mask layer over the polymer mask under-layer;
forming a photoresist mask over the dielectric hard mask;
transferring the image of the photoresist mask onto the dielectric hard mask;
placing the wafer into a chamber of a reactive ion etching tool; and
performing a reactive ion etching to transfer the image of the dielectric hard mask onto the polymer mask under-layer, the reactive ion etching being performed in the reactive ion etching tool while inputting both an oxygen containing gas and a nitrogen containing gas into the chamber of the reactive ion etching tool.

12. The method as in claim 11 wherein the oxygen containing gas is input into the chamber at a first flow rate and the nitrogen containing gas is input into the chamber at a second gas flow rate and wherein the ratio of the first flow rate to the second flow rate is 15 to 1.5.

13. The method as in claim 11 wherein the reactive ion etching is performed with a total gas pressure of 2 to 10 mT within the chamber of the reactive ion etching tool.

14. The method as in claim 11 wherein the oxygen containing gas comprises CO₂ and the nitrogen containing gas comprises N₂.

15. The method as in claim 11 wherein the ratio of bias power to source power is 0.5 to 1.5.

16. The method as in claim 11 wherein the polymer mask under-layer comprises a polymer mask material.

17. The method as in claim 11 wherein the polymer mask under-layer comprises a polymer mask material having a curing temperature of about 150 to 250 degrees C.

18. The method as in claim 11 wherein the dielectric hard mask comprises a Si containing material.

19. The method as in claim 11 further comprising after performing the reactive ion etching, performing an ion milling to transfer the image of the polymer mask under-layer onto the ion milling hard mask and the magnetic write pole material.

20. The method as in claim 11 further comprising after depositing the dielectric hard mask and before forming the photoresist mask, depositing a Bottom Antireflective Coating.
